(19) United States
(12) Patent Application Publication
(10) Pub. No.: US 2011/0267479 A1
(43) Pub. Date: Nov. 3, 2011

(54) IMAGE CAPTURE DEVICE, ELECTRONIC DEVICE, DATA PROCESSING SYSTEM, AND COMPUTER PROGRAM

(75) Inventors: Toru HINO, Osaka (JP); Yoichi HIRATA, Osaka (JP); Takeshi SAEKI, Osaka (JP); Masafumi NOSAKA, Osaka (JP); Masahiko KUWAHARA, Osaka (JP); Yasuhiro SASANO, Osaka (JP); Kazuyuki MURAKAMI, Osaka (JP)

(73) Assignee: PANASONIC CORPORATION, Osaka (JP)

(21) Appl. No.: 12/961,738

(22) Filed: Dec. 7, 2010

(30) Foreign Application Priority Data
Dec. 8, 2009 (JP) 2009-278121

(51) Int. Cl. H04N 5/228; H04N 5/225; H04N 5/232

(52) U.S. Cl. 348/207.11; 348/222.1; 348/211.99; 348/E05.042; 348/E05.024; 348/E05.031

(57) ABSTRACT

An image capture device having an image capture function includes an interface which receives first data from an external electronic device; and a processing section including a circuit which is used for transcode processing. The processing section performs the transcode processing on the first data using the circuit to generate second data. The interface transmits the generated second data to the electronic device.

### BACKGROUND OF THE INVENTION

1. Field of the Invention

The present invention relates to an image capture device having a transcode processing function, an electronic device connectable with such an image capture device, and a computer program for such an image capture device and such an electronic device.

2. Description of the Related Art

Japanese Patent Application Laid-Open Publication No. 2009-27257 discloses a video camera device for converting video data of the H. 264 format into video data of the MPEG2 format. Such processing of converting data of one format into data of another format is generally called “transcode processing”. The data may be video data or audio data.

The above-mentioned video camera device can record video data on an HDD and an optical disc (more specifically, a DVD). The video camera device transcodes video data recorded on an HDD in the H. 264 format into the MPEG2 format, and dubs the transcoded video data on an optical disc.

Owing to this, a user can select a location and a format for storing captured video data from a variety of alternative options.

Using the video camera device disclosed in Japanese Patent Application Laid-Open Publication No. 2009-27257 mentioned above, the user can select a location for storing transcoded video data. However, the video camera device described in Japanese Patent Application Laid-Open Publication No. 2009-27257 can perform transcode processing only on video data stored on an HDD of the video camera device itself. Thus, the conventional art is not considered to allow the user to select video data to be transcoded from any storage location.

When wishing to perform transcode processing on video data which is not stored on the HDD of the video camera device itself, for example, video data stored on an HDD of a personal computer, the user can utilize application software for the personal computer. However, transcode processing is time-consuming even when a graphic chip set or a video card of a personal computer is used. For example, it occasionally takes as long as six hours to transcode 2-hour video data of the H. 264 format into video data of the MPEG2 format. During this time, the user should stop other works to be performed using the personal computer because the load of the transcode processing on the personal computer is heavy.

### SUMMARY OF THE INVENTION

An object of the present invention is to provide an arrangement for transcoding video data at a high speed regardless of the storage location of the video data.

An image capture device according to the present invention has an image capture function and includes an interface which receives first data from an external electronic device; and a processing section including a circuit which is used for transcode processing, the processing section performing the transcode processing on the first data using the circuit to generate second data. The interface transmits the second data to the electronic device.

The image capture device further includes a controller which controls communication with the electronic device via the interface. The image capture device is driven by power of a power supply provided from an electrical outlet or by power supplied from a battery; before the interface receives the first data, the controller transmits information specifying the type of the power supply currently driving the image capture device to the electronic device via the interface; and when the image capture device is currently driven by the power of the power supply, the interface receives the first data from the electronic device.

The image capture device further includes a controller which controls communication with the electronic device via the interface. Before receiving the first data, the interface receives information specifying the type of the transcode processing from the electronic device; and based on the information specifying the type of the transcode processing, the controller determines whether or not the specified type of transcode processing can be performed on the first data; and when determining that the specified type of transcode processing can be performed on the first data, the controller transmits response data which indicates that the transcode processing can be performed to the electronic device via the interface, and then the interface receives the first data from the electronic device.

The image capture device further includes a controller which controls communication with the electronic device via the interface; and a storage section which stores the first data. The controller determines whether or not a prescribed amount of the first data has been stored on the storage section; and when the prescribed amount of the first data has been stored on the storage device, the processing section performs the transcode processing on the first data using the circuit.

The image capture further includes a controller which controls communication with the electronic device via the interface. The controller transmits a part of the second data generated by the transcode processing performed on the first data to the electronic device via the interface before the transcode processing is completed.

The image capture device further includes a controller which controls communication with the electronic device via the interface. The controller transmits the second data to the electronic device via the interface after the transcode processing on the first data is completed.

An electronic device according to the present invention is connected with the image capture device including a circuit which is used for transcode processing. The image capture device being driven by power of a power supply provided from an electrical outlet or by power supplied from a battery. The electronic device includes an interface which receives, from the image capture device, information specifying the type of the power supply currently driving the image capture device; a storage section which stores first data; and a processor which determines whether or not to transmit the first data to the image capture device in accordance with the type of the power supply currently driving the image capture device. When the image capture device is currently driven by the power of the power supply, the processor transmits the first data to the image capture device via the interface, and receives second data obtained by the transcode processing performed on the first data using the circuit; and when the image capture device is currently driven by the battery, the processor does not transmit the first data to the image capture device.

Before transmitting the first data, the processor may transmit information specifying the type of the transcode processing to the image capture device via the interface, and may receive, from the image capture device, response data which indicates whether or not the transcode processing of the type specified by the information can be performed.

In the case where the response data indicates that the transcode processing of the type specified by the information can be performed, the processor may transmit the first data to the image capture device.

The processor may receive a part of the second data generated by the transcode processing performed on the first data from the image capture device via the interface before the transcode processing is completed.

The processor may receive the second data from the image capture device via the interface after the transcode processing on the first data is completed.

A data processing system according to the present invention includes an electronic device and an image capture device having an image capture function. The electronic device includes a storage section which stores first data; and a first interface which transmits the first data to the image capture device. The image capture device includes a second interface which receives the first data from the electronic device; and a processing section including a circuit which is used for transcode processing, the processing section performing the transcode processing on the first data using the circuit to generate second data. The image capture device transmits the second data via the second interface; and the electronic device receives the second data via the first interface.

A computer program according to the present invention is executable by a computer of an image capture device having an image capture function and stored on a non-transitory storage medium. The image capture device includes a controller acting as a computer, an interface, and a processing section including a circuit usable for transcode processing. The computer program causes the controller to execute the steps of receiving first data from an external electronic device via the interface; performing the transcode processing on the first data using the circuit to generate second data; and transmitting the second data to the electronic device via the interface.

Another computer program according to the present invention is executable by a computer of an electronic device and stored on a non-transitory storage medium. The electronic device includes a computer, a storage section which stores first data and an interface, and the image capture device is connected with an image capture device. The image capture device includes a circuit which is used for transcode processing, and is driven by power of a power supply provided from an electrical outlet or power supplied from a battery. The computer program causes the computer to execute the steps of receiving information specifying the type of the current driving power supply from the image capture device via the interface; not transmitting the first data to the image capture device when the image capture device is currently driven by the battery, and transmitting the first data to the image capture device via the interface when the image capture device is currently driven by the power of the power supply; and receiving, via the interface, second data obtained by the transcode processing performed on the first data using the circuit when the first data is transmitted to the image capture device.

According to the present invention, an image capture device including a circuit usable for transcode processing receives data from an electronic device, and performs the transcode processing on the data. Owing to this, the transcode processing can be performed regardless of the storage location of the data, and also at a high speed by a circuit usable the transcode processing.

### BRIEF DESCRIPTION OF THE DRAWINGS

FIG. 1 is a schematic view showing a structure of a transcode processing system 10 in an embodiment according to the present invention.

FIG. 2 is a block diagram showing a structure of a digital video camera 100.

FIG. 3 shows main elements of the digital video camera 100 involved in transcode processing.

FIG. 4 is a block diagram showing a structure of a PC 500.

FIG. 5 is a flowchart showing a processing sequence of the digital video camera 100 for the transcode processing.

FIG. 6 is a flowchart for illustrating showing a confirmation operation of the PC 500 after editing software is started.

FIG. 7 is a flowchart for illustrating the confirmation operation of the PC 500 after the editing software is started.

FIG. 8 is a flowchart for illustrating an initial negotiation performed between the digital video camera 100 and the PC 500 after the confirmation operation which is performed after the editing software is started.

FIG. 9 is a flowchart for illustrating the initial negotiation performed between the digital video camera 100 and the PC 500 after the confirmation operation which is performed after the editing software is started.

FIG. 10 is a flowchart for illustrating a sequence by which the PC 500 writes video data on the digital video camera 100 before the digital video camera 100 performs the transcode processing.

FIG. 11 is a flowchart for illustrating the sequence by which the PC 500 writes the video data on the digital video camera 100 before the digital video camera 100 performs the transcode processing.

FIG. 12 is a flowchart for illustrating a sequence by which the PC 500 reads video data from the digital video camera 100 before the digital video camera 100 performs the transcode processing.

FIG. 13 is a flowchart for illustrating the sequence by which the PC 500 reads the video data from the digital video camera 100 before the digital video camera 100 performs the transcode processing.

### DETAILED DESCRIPTION OF PREFERRED EMBODIMENTS

Hereinafter, embodiments of the present invention will be described with reference to the attached drawings.

The present invention is embodied as an image capture device, an electronic device, and/or a data processing system including an image capture device and an electronic device. For example, the image capture device is a digital video camera, and the electronic device is a personal computer (hereinafter, referred to as a “PC”). The data processing system is a transcode processing system including a digital video camera and a PC. The present invention also encompasses a computer program for operating each of an image capture device and a electronic device, and a storage medium storing such a computer program.

Prior to describing the embodiments, the term “transcode processing” used herein will be described.

As described regarding the background art in this specification, “transcode processing” means processing of converting data of one format into data of another format. More specifically, “transcode processing” means format conversion processing such as processing of converting the compression format of video data, p/i conversion processing, processing of converting video data of a high definition image quality into video data of a standard image quality, and the like. “Transcode processing” also encompasses processing of converting the format of audio data.

For example, processing of converting the compression format of video data compressed in conformity to the H.264 format into the MPEG2, processing of converting video data of 60p (progressive) into video data of 60i (interlace), and processing of converting video data having an image size of 1920×1080 into video data having an image size of 640×480 are encompassed the “transcode processing” in the sense of this specification. Processing of converting audio data of the WAV format into audio data of the DSD format is also encompassed the “transcode processing” in the sense of this specification.

Hereinafter, embodiments of the present invention will be described.

### [1. Structure]

[1-1. Structure of the Entire System]

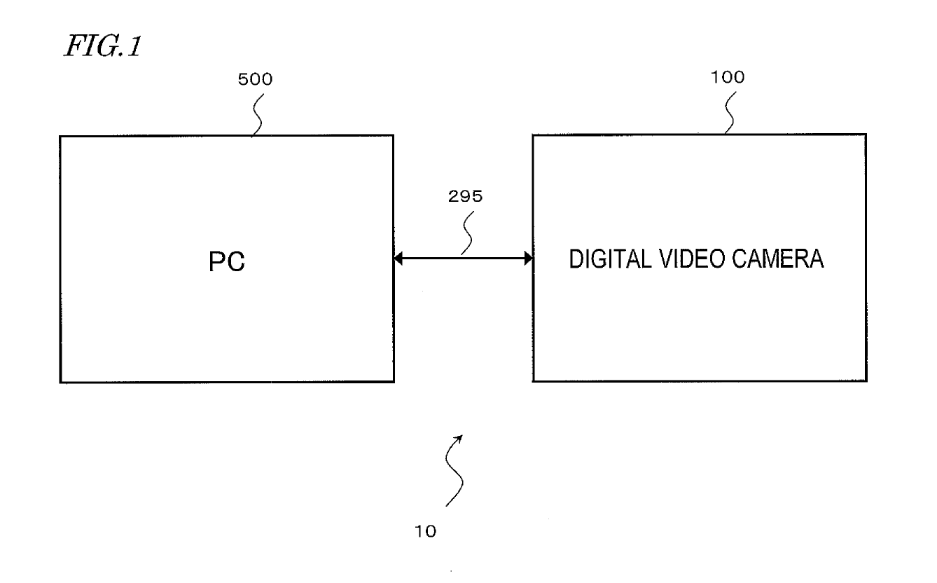

With reference to FIG.1, a transcode processing system including a digital video camera in this embodiment will be described.

FIG. 1 is a schematic view showing a structure of a transcode processing system 10 in this embodiment. The transcode processing system 10 includes a digital video camera 100 and a PC 500.

The digital video camera 100 is connected with the PC 500, which is an electronic device, via a USB cable 295 or the like. The digital video camera 100 can perform transcode processing on video data acquired from the PC 500 via the USB cable 295.

Conventionally, for performing transcode processing on video data stored on a storage medium other than an HDD built in a digital video camera, for example, stored on an HDD of a PC, there is no other way than using the PC. However, in this embodiment, the digital video camera 100 is used to perform transcode processing on video data stored on the HDD of the PC.

The digital video camera 100 can write a video signal on various types of storage mediums. As is well known, there are many types of storage mediums such as SC memory cards, DVDs, BDs, and the like; and there are many types of moving picture formats such as the MPEG2 format, H.264 format, VC-1 format and the like. The moving picture formats usable to write data are different by type of storage mediums. Therefore, the digital video camera 100 needs to have video processing functions for generating data of the respective video formats. The digital video camera 100 can output video and audio data which are being captured or have been captured in a digital format or an analog format, and so needs to have a format conversion processing function.

For carrying out the above-mentioned video processing function and format conversion processing function, many of recent digital video cameras include a video processing circuit for performing video processing necessary to carry out such functions. In many cases, the video processing circuit is considered to be specialized for the processing of the digital video camera. Accordingly, transcode processing can be performed at a much higher speed with much less power by a digital video camera than by a universal image processing circuit of a PC or the like using software.

Hence, in this embodiment, an arrangement for performing transcode processing, more specifically, a protocol for performing transcode processing, even on video data stored on the HDD of the PC 500 using the digital video camera at a high speed is provided. Owing to this, the video data can be transcoded at a high speed regardless of the storage location of the video data.

In this embodiment, the digital video camera 100 and the PC 500 are connected to each other via the USB cable 295, but this is merely an example. The digital video camera 100 and the PC 500 may be connected to each other via any of various communication mediums. For example, a cable conforming to the IEEE1394 format, a LAN cable of the Ethernet (registered trademark) format, or a wireless communication maybe used. In addition, the digital video camera 100 and the PC 500 do not need to be connected in a one-to-one form, but maybe connected via, for example, the Internet.

[1-2. Structure of the Digital Video Camera]

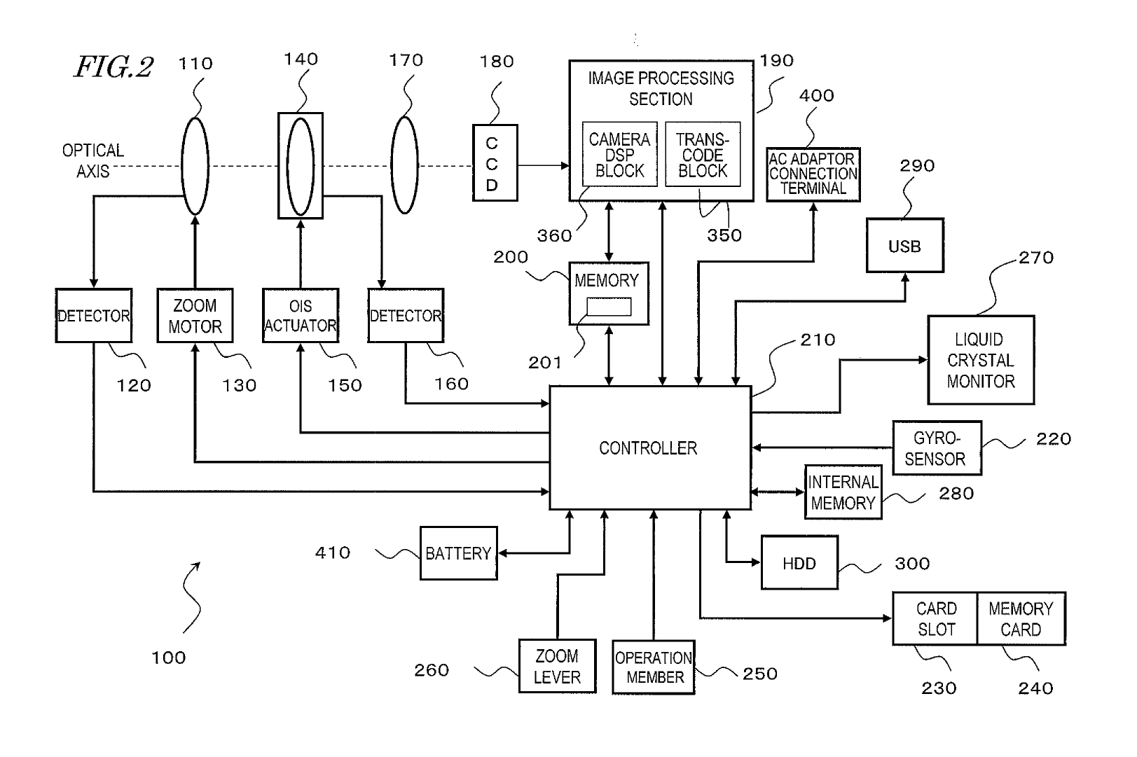

Now, with reference to FIG.2, an electrical structure of the digital video camera 100 will be described. FIG.2 is a block diagram showing a structure of the digital video camera 100. The digital video camera 100 captures an image of a subject, formed by an optical system including a zoom lens 110 and the like, by a CCD image sensor 180. The video data generated by the CCD image sensor 180 is subjected to various types of processing by an image processing section 190 and stored on a memory card 240. The video data stored on the memory card 240 can be displayed by a liquid crystal display monitor 270. Hereinafter, the structure of the digital video camera 100 will be described in detail.

The optical system of the digital video camera 100 includes the zoom lens 110, an optical image stabilizer (OIS) 140, and a focus lens 170. The zoom lens 110 moves along an optical axis of the optical system and thus can enlarge or reduce the image of the subject. The focus lens 170 moves along the optical axis of the optical system to adjust the focus of the image of the subject.

The OIS 140 includes a built-in correction lens movable in a plane vertical to the optical axis. The OIS 140 drives the correction lens in such a direction as to counteract the unintentional movement of the digital video camera 100 to reduce the unintentional movement of the subject.

The zoom motor 130 drives the zoom lens 110. The zoom motor 130 may be realized by a pulse motor, a DC motor, a linear motor, a servo motor or the like. The zoom motor 130 may drive the zoom lens 110 via a mechanism such as a cam mechanism, a ball screw or the like. A detector 120 detects the position of the zoom lens 110 on the optical axis. The detector 120 outputs a signal on the position of the zoom lens by a switch such as a brush or the like in accordance with the movement of the zoom lens 110 in a direction of the optical axis.

An OIS actuator 150 drives the correction lens in the OIS 140 in a plane vertical to the optical axis. The OIS actuator 150 may be realized by a planar coil, an ultrasonic motor or the like. A detector 160 detects an amount of movement of the correction lens in the OIS 140.

A CCD image sensor 180 captures the image of the subject formed by the optical system including the zoom lens 110 and the like to generate video data. The CCD image sensor 180 performs various operations such as exposure, transfer, electronic shutter operation and the like.

An image processing section 190 performs various types of image processing. The image processing section 190 includes a plurality of processing blocks in accordance with the types of the image processing. The image processing section 190 includes, for example, a transcode block 350 and a camera DSP block 360.

The transcode block 350 is used for transcode processing to convert the format of data. In this embodiment, the transcode block 350 performs transcode processing on video data.

The camera DSP block 360 performs various types of processing on the video data generated by the CCD image sensor 180. More specifically, the camera DSP block 360 performs prescribed processing on the video data generated by the CCD image sensor 180 to generate video data to be displayed by the liquid crystal display monitor 270. The camera DSP block 360 also generates video data to be re-stored on the memory card 240. For example, the camera DSP block 360 performs various types of processing such as gamma correction, white balance correction, scratch correction and the like on the video data generated by the CCD image sensor 180. The camera DSP block 360 also compresses the video data generated by the CCD image sensor 180 by, for example, a compression format in conformity to the MPEG2 format or the H. 264 format. The image processing section 190 may be realized by a DSP, a microcomputer or the like.

A controller 210 controls the entirety of the digital video camera 100. The controller 210 may be realized by a semiconductor element or the like. The controller 210 may be structured of only hardware, or a combination of hardware and software. The controller 210 may be realized by a microcomputer or the like.

A memory 200 acts as a work memory of the image processing section 190 and the controller 210. The memory 200 may be realized by, for example, a DRAM, a ferroelectric memory or the like. The memory 200 stores a computer program 201 which allows the controller 210 to perform the processing described below.

The liquid crystal display monitor 270 can display an image represented by the video data generated by the CCD image sensor 180 or an image represented by the video data read from the memory card 240.

A gyrosensor 220 is formed of a vibration element or the like such as a piezoelectric element or the like. The gyrosensor 220 vibrates a vibration element such as a piezoelectric element or the like at a certain frequency and converts a Coriolis force into a voltage to obtain angular velocity information. By obtaining the angular velocity information from the gyrosensor 220 and driving the correction lens in the OIS in such a direction as to counteract the shake, the digital video camera 100 corrects the unintentional movement of the hand of the user.

A card slot 230 allows the memory card 240 to be attached thereto or detached therefrom. The card slot 230 is connectable with the memory card 240 mechanically and electrically. The memory card 240 has a flash memory, a ferroelectric memory or the like provided therein and thus can store data.

An internal memory 280 is formed of a flash memory, a ferroelectric memory or the like. The internal memory 280 stores, for example, a control program for controlling the entirety of the digital video camera 100. This control program is developed on the memory 200 as the computer program 201.

An operation member 250 is a member for receiving an image capture instruction from the user. A zoom lever 260 is a member for receiving an instruction to change the zoom magnification from the user.

A USB interface 290 is a connection interface for connecting the digital video camera 100 and an external device such as the PC 500 or the like to each other. For example, by connecting the USB interface 290 of the digital video camera 100 and a USB interface (not shown) provided in an external device such as the PC 500 or the like to each other via the USB cable 295 (FIG. 1), the digital video camera 100 and the external device can communicate with each other. Owing to this, the digital video camera 100 can perform a command communication with an external device such as the PC 500.

A hard disc drive 300 (hereinafter, referred to as the “HDD 300”) includes a buffer, a hard disc as a magnetic storage medium, a control circuit for controlling write/read of data on/from the hard disc (none of these is shown), and the like, and is incorporated in a main body of the digital video camera 100. In this specification, for the sake of explanation, the HDD 300 is described as one storage medium of video data for the digital video camera 100.

An AC adaptor connection terminal 400 is an interface for connecting the digital video camera 100 and an AC adaptor to each other. For example, the AC adaptor connection terminal 400 of the digital video camera 100 and a power supply terminal (home-use electrical outlet) can be connected to each other via an AC adaptor. The digital video camera 100 can receive electric power from the power supply via the home-use electrical outlet and the AC adaptor connection terminal 400.

A battery 410 is a secondary cell for supplying the digital video camera 100 with power necessary for an operation thereof. The digital video camera 100 operates by receiving power from the battery 410 mounted thereon.

[1-3. Detailed Structure of the Transcode-Related Block]

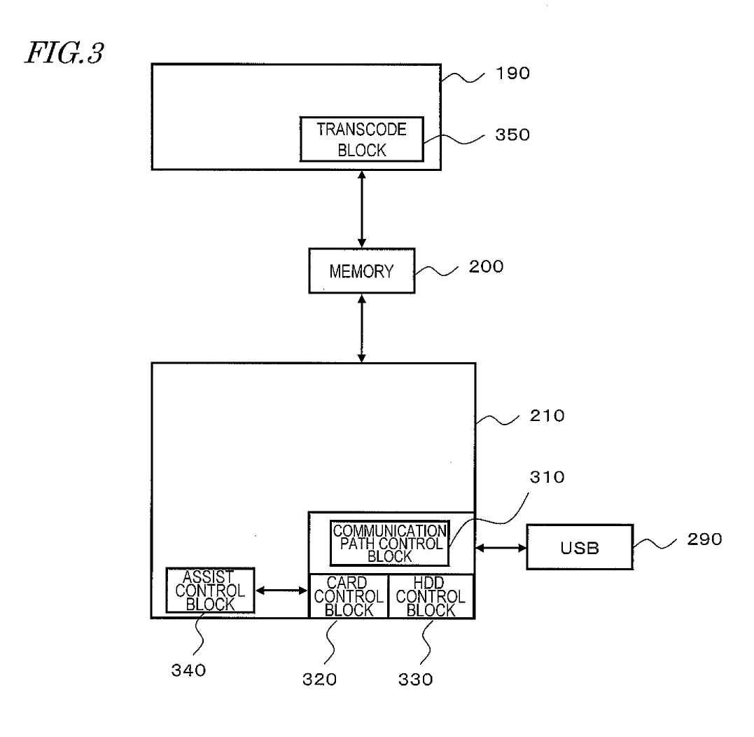

For transcode processing, among processing performed by the digital video camera 100, mainly the controller 210, the memory 200 and the image processing section 190 are involved. Among the elements of the digital video camera 100, main elements involved in transcode processing will be described in detail with reference to FIG. 3.

FIG. 3 shows main elements of the digital video camera 100 involved in transcode processing.

As described above, in the image processing section 190, the transcode block 350 performs transcode processing.

The controller 210 includes, as blocks involved in transcode processing, a communication path control block 310, a card control block 320, an HDD control block 330, and an assist control block 340.

The communication path control block 310 can change the USB connection state between the digital video camera 100 and the PC 500. For example, the communication path control block 310 can change a USB connection state by which PC 500 can only access the HDD 300 in the digital video camera 100 to a USB connection state by which the PC 500 can access both of the HDD 300 and the memory card 240.

The communication path control block 310 interprets a command received from the PC 500 via the USB interface 290. Specifically, the communication path control block 310 interprets whether the PC 500 wishes to access the memory card 240, the HDD 300 or the assist control block. Based on the interpretation results, the communication path control block 310 access each of the control blocks.

The card control block 320 processes an access request to the memory card 240 received from the communication path control block 310.

The HDD control block 330 processes an access request to the HDD 300 received from the communication path control block 310.

Based on the command received from the communication path control block 310, the assist control block 340 controls the transcode block 350 and the memory 200. Specifically, the assist control block is used for causing the transcode block 350 to perform transcode processing on the video data received from an external device connected via the USB interface 290.

In this embodiment, the transcode block 350 is described as being provided in the image processing section 190, but this is merely an example. The blocks shown in FIG. 3 involved in transcode processing may be provided as a single LSI circuit, and the camera DSP block 360 may be provided as a camera DSP chip circuit. At this point, a microcode is read into a software stack structured on a hardware circuit in the LSI and is executed, and thus the LSI circuit can be operated as each of the blocks described above.

The above-described LSI may further include, for example, an encoder block for recording and a decoder block for reproduction (neither is shown).

[1-4. Structure of the PC]

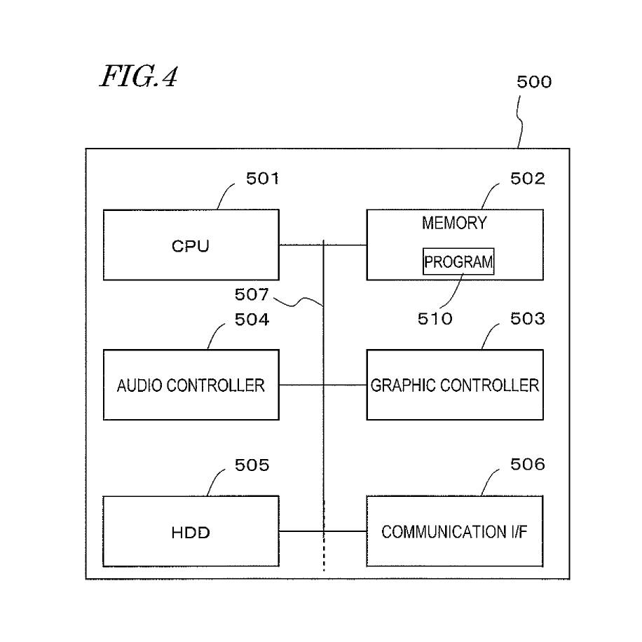

FIG. 4 is a block diagram showing a structure of the PC 500. The PC 500 includes a processor (CPU) 501, a memory 502, a graphic controller 503, an audio controller 504, an HDD 505, a communication interface 506, and a bus 507.

The CPU 501 controls the operation of the entirety of the PC 500. The memory 502 stores a computer program 510 for performing the processing described below. The graphic controller 503 generates an image to be displayed by a display device (not shown) of the PC 500, and outputs the image to the display device. The audio controller 504 generates an audio signal, and outputs the audio signal via a speaker or an audio output terminal (not shown) of the PC 500. The HDD 505 stores video data to be transmitted to the digital video camera 100 and subjected to transcode processing. The communication interface 506 connects the PC 500 and the digital video camera 100 to each other to perform communication. In this embodiment, the communication interface 506 is a USB terminal.

The hardware structure of the PC 500 shown in FIG. 4 is well known. It should be noted that the CPU 501 of the PC 500 executes the program 510 stored on the memory 502 to communicate with the digital video camera 100 and thus can cause the PC 500 to perform a prescribed operation. The details of the operation will be described later.

### [2. Operation]

[2-1. Transcode Processing on Video Data in the Digital Video Camera]

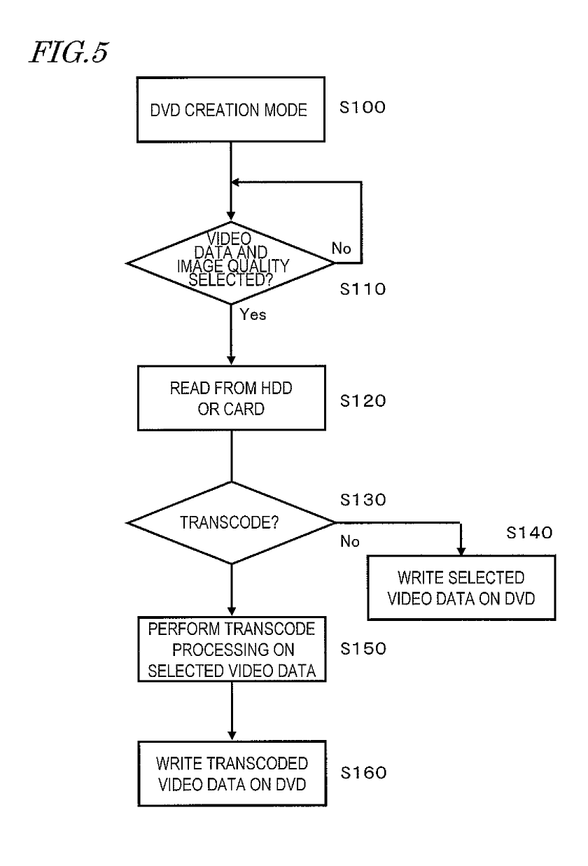

Hereinafter, with reference to FIG. 5, a sequence by which the digital video camera 100 transcodes video data stored on the memory card 240 or the HDD 300 in the digital video camera 100 itself. FIG. 5 is a flowchart showing processing sequence of the digital video camera 100 for transcode processing.

The user can connect an external DVD (Digital Versatile Disc) drive (not shown) to the digital video camera 100 via the USB interface 290. When the DVD drive is connected, the controller 210 waits until receiving, from the user, an instruction to write the video data (stored on the memory card 240 or the HDD 300) on a DVD or to reproduce a DVD. When receiving an instruction to write video data on a DVD from the user, the digital video camera 100 starts an operation in a DVD creation mode (S100).

When the DVD creation mode operation is started, the controller 210 waits until receiving an instruction on what type of DVD is to be created from the user (S110). Specifically, the controller 210 waits until the user selects which of the video data stored on the memory card 240 or the HDD 300 is to be written on the DVD and in which image quality the video data is to be written on the DVD. The digital video camera 100 can write video data on the DVD either in the high definition image quality or the standard image quality. The digital video camera 100 compresses video data of the high definition image quality in a compression format in conformity to the H.264 format.

Upon receiving an instruction on which type of DVD is to be created, the controller 210 reads the video data selected by the user from the memory card 240 or the HDD 300 onto the memory 200 (S120). Upon reading the video data onto the memory 200, the controller 210 determines whether or not the instruction from the user requires transcode processing (S130). For example, the controller 210 determines whether or not the instruction received from the user is an instruction to write the video data of the high definition image quality on the DVD as video data of the standard image quality.

When determining that the instruction from the user is not an instruction to write the video data of the high definition image quality on the DVD as video data of the standard image quality, the controller 210 writes the video data selected by the user on the DVD without performing transcode processing (S140).

When determining that the instruction from the user is an instruction to write the video data of the high definition image quality on the DVD as video data of the standard image quality, the controller 210 controls the image processing section 190 to perform transcode processing of converting the video data selected by the user from the high definition image quality into the standard image quality and also converting the compression format from a compression format in conformity to the H.264 format into a compression format in conformity to the MPEG2 format (S150).

When the image processing section 190 completes the transcode processing, the controller 210 writes the transcoded video data on the DVD (S160).

[2-2. Transcode Processing on Video Data Received from the PC 500]

As described regarding FIG. 1, in this embodiment, the digital video camera 100 receives video data from the PC 500, performs transcode processing on the video data, and then transmits the transcoded video data to the PC 500. At this point, unless a connection regarding the transcode processing is established between the digital video camera 100 and the PC 500, the digital video camera 100 and the PC 500 cannot mutually operate to perform the processing.

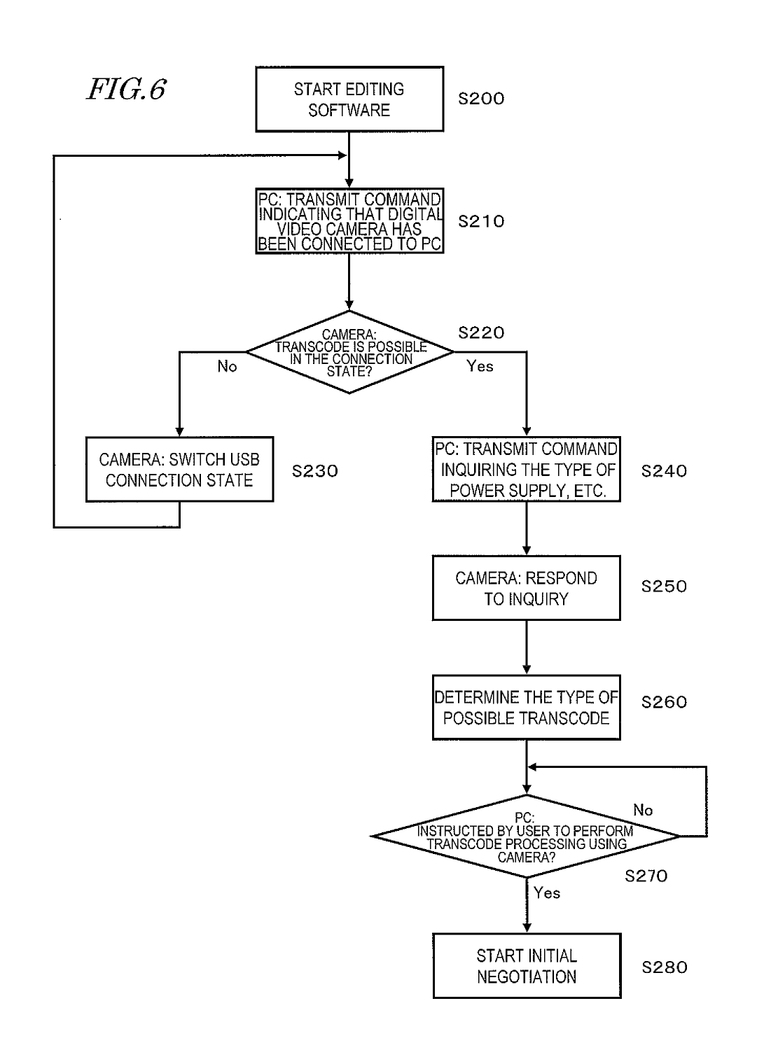

With reference to FIG. 6 through FIG. 13, a sequence performed between the digital video camera 100 and the PC 500 for transcode processing will be described. It should be noted that the processing performed by the PC 500 in the following description is actually performed by the CPU 501 which executes the program 510.

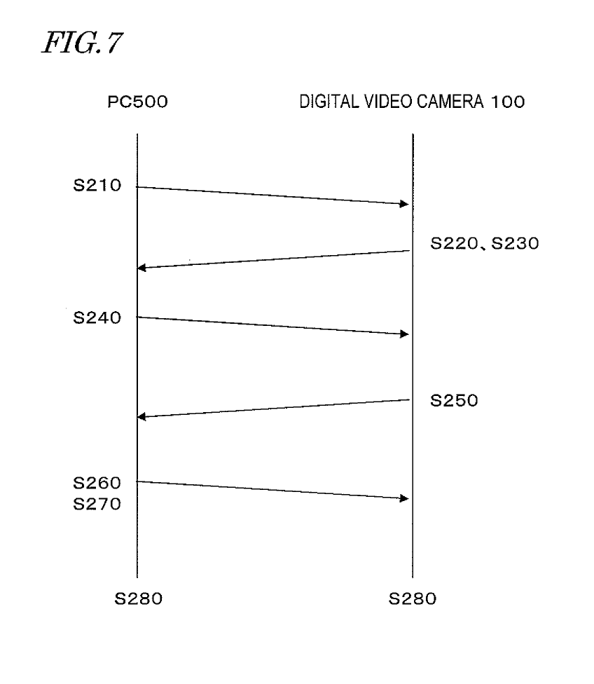

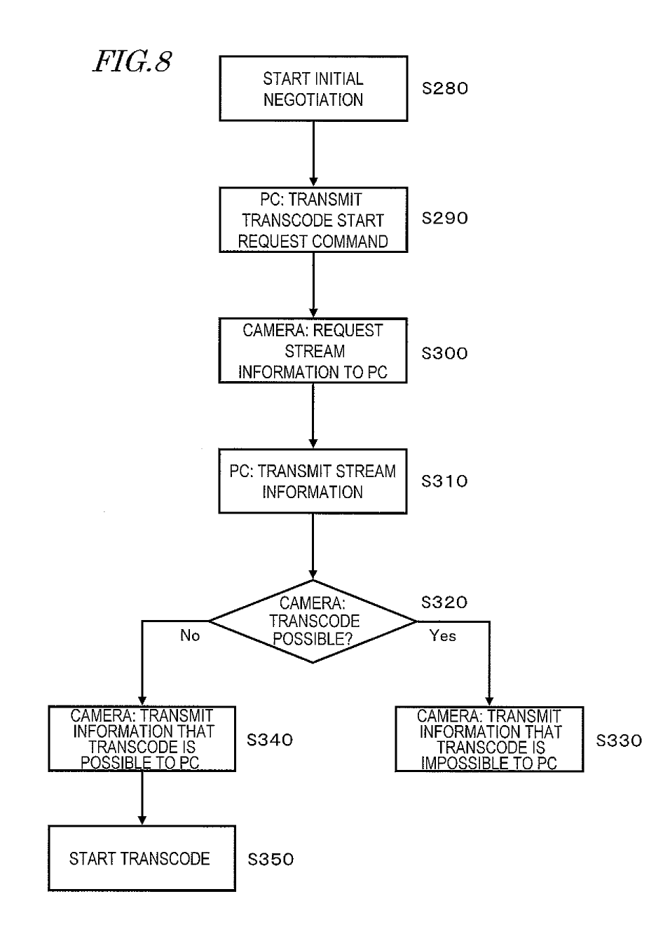

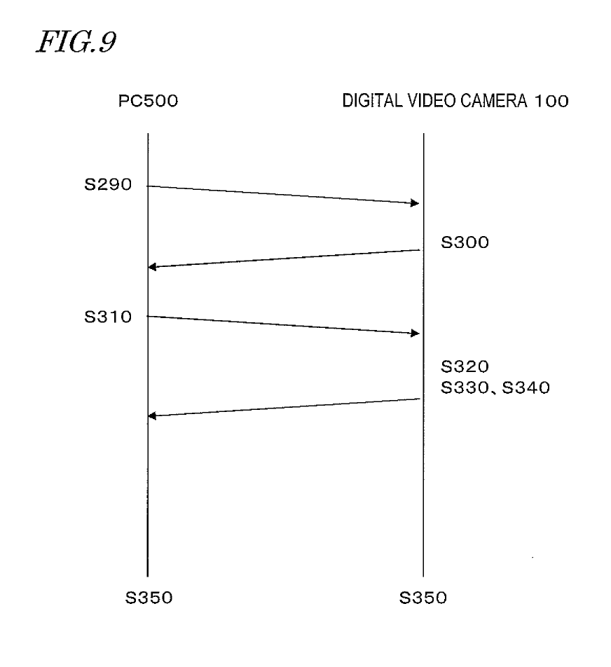

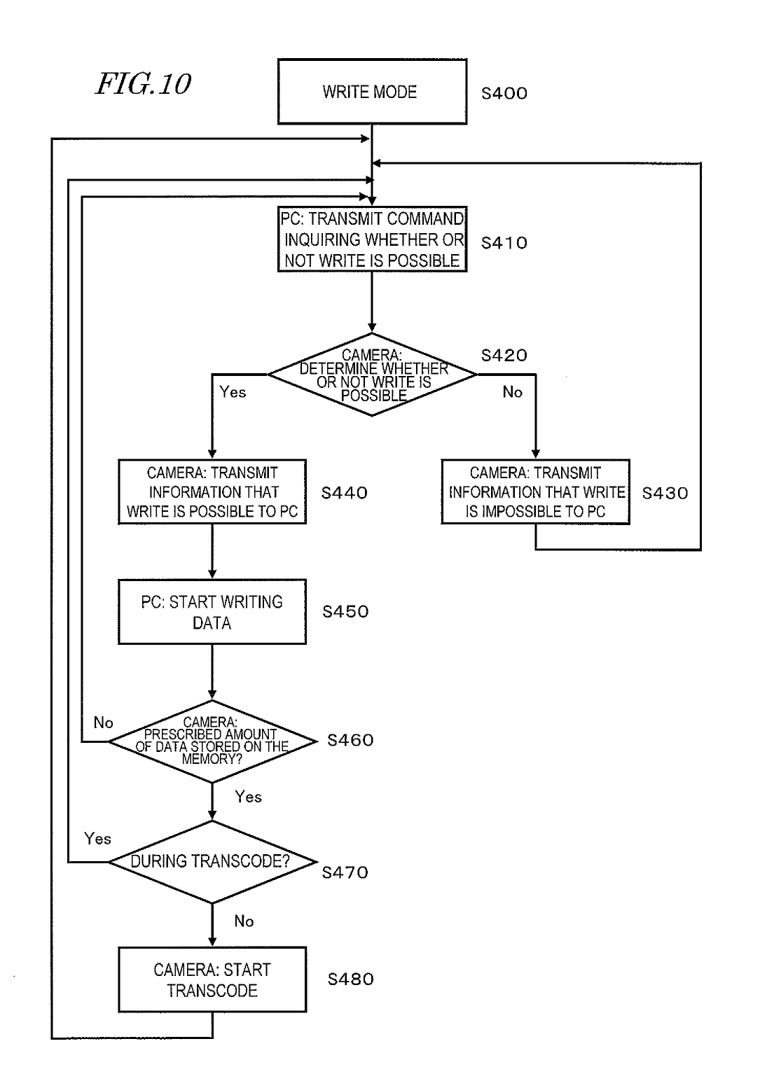

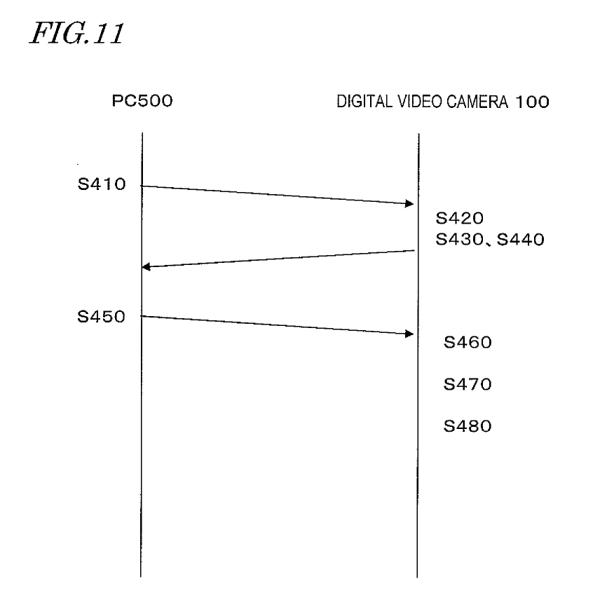

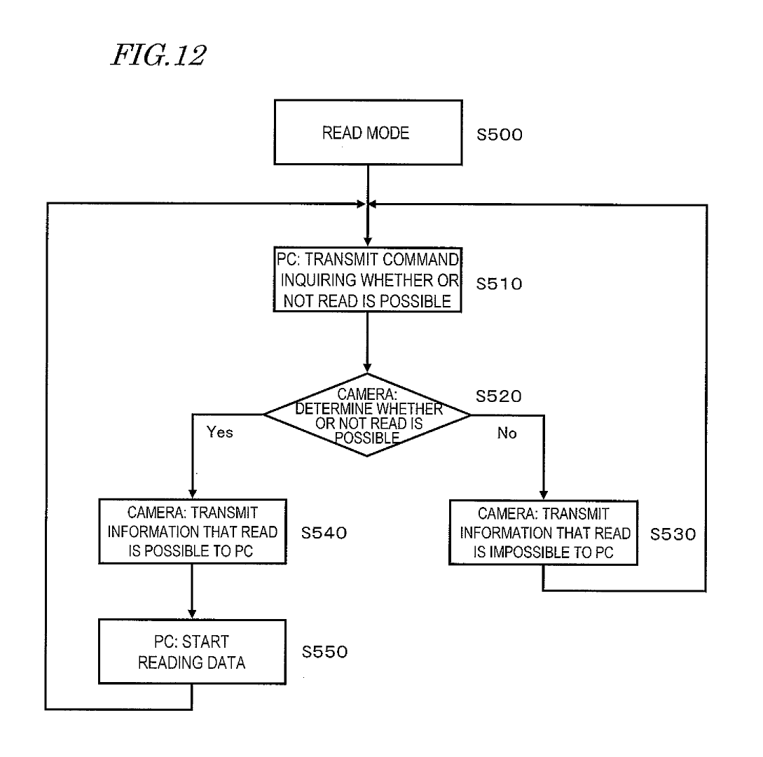

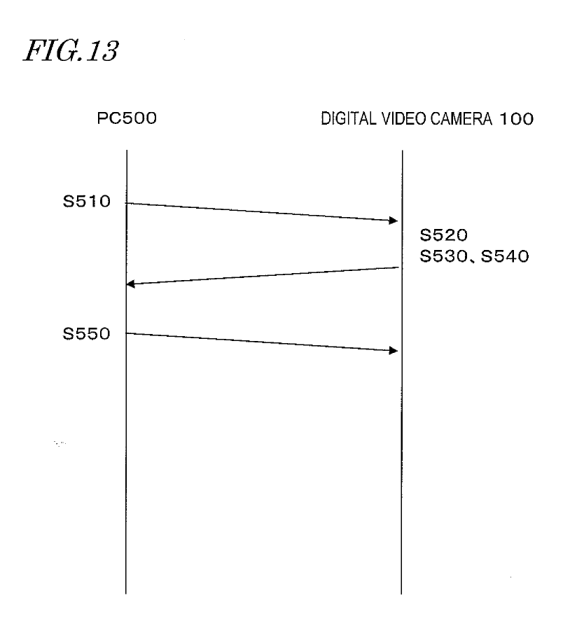

FIG. 6 and FIG. 7 are flowcharts for illustrating a conformation operation after editing software is started by the PC 500. FIG. 8 and FIG. 9 are flowcharts for illustrating an initial negotiation performed between the digital video camera 100 and the PC 500 after the confirmation operation which is performed after the editing software is started. FIG. 10 and FIG. 11 are flowcharts for illustrating a sequence by which the PC 500 writes video data on the digital video camera 100 in order to allow the digital video camera 100 to perform the transcode processing. FIG. 12 and FIG. 13 are flowcharts for illustrating a sequence by which the PC 500 reads video data from the digital video camera 100 in order to allow the digital video camera 100 to perform the transcode processing.

FIG. 6, FIG. 8, FIG. 10 and FIG. 12 all show the processing of the entirety of the transcode processing system 10 (FIG. 1). For the sake of understanding, the processing blocks performed by the digital video camera 100 are labeled “camera”, and the processing blocks performed by the PC 500 are labeled “PC”. The processing blocks not labeled are performed by both of the digital video camera 100 and the PC 500.

Meanwhile, FIG. 7, FIG. 9, FIG. 11 and FIG. 13 all clearly show the flows of processing performed by the PC 500 and the digital video camera 100. The processing performed by the PC 500 and the processing performed by the digital video camera 100 are respectively defined by the computer programs 510 and 201 mentioned above.

Hereinafter, with reference to mainly FIG. 6, FIG. 8, FIG. 10 and FIG. 12, the sequence of transcoding the video data received from the PC 500 will be described sequentially.

[2-2-1. Confirmation Operation After the Video Data Editing Software is Started]

With reference to FIG. 6, the confirmation operation after the video data editing software is started by the PC 500 will be described. When the PC 500 detects that the digital video camera 100 is connected, or when the user operates to start the editing software, the PC 500 starts the editing software (S200). Upon starting the editing software, the PC 500 transmits, to the digital video camera 100, a command indicating that the digital video camera 100 has been connected to the PC (S210).

Upon receiving the command indicating that the digital video camera 100 has been connected to the PC, the digital video camera 100 determines whether or not the connection state between the digital video camera 100 and the PC 500 via the USB allows the video data received from the PC 500 to be transcoded (S220).

When determining that the connection state does not allow the video data to be transcoded, the digital video camera 100 switches the connection state with the PC 500 via the USB interface 290 (S230). Specifically, the digital video camera 100 switches the connection state with the PC 500 into a state in which the transcode processing can be performed. The reason for this switching will be described below.

For transcode processing, the assist control block 340 is used. As described regarding FIG. 3, the assist control block 340 is only connected to the card control block 320, and is not connected to the HDD control block 330. Accordingly, in the case where the digital video camera 100 is connected to the PC 500 in the state where the digital video camera 100 can access only the HDD 300, the digital video camera 100 cannot perform transcode processing on the video data received from the PC 500.

Hence, in the case where the digital video camera 100 is connected with the PC 500 in the state where the digital video camera 100 can access only the HDD 300, the digital video camera 100 once cancels the connection with the PC 500 via the USB interface 290 in step S230. After cancelling the connection, the digital video camera 100 establishes the connection with the PC 500 via the USB interface 290 in the state where the digital video camera 100 can access both of the memory card 240 and the HDD 300. Owing to this, the connection state between the digital video camera 100 and the PC 500 can automatically become a connection state in which transcode processing can be performed.

By contrast, when the connection state allows transcode processing to be performed in step S220, the digital video camera 100 receives a command which inquires the type of the power supply or the like from the PC 500 (S240). Specifically, the digital video camera 100 receives, from the PC 500, an inquiry on whether the digital video camera 100 is currently driven by an AC adaptor connected to the power supply outlet or by the battery 410, and an inquiry on the type of transcode processing which can be performed by the digital video camera 100.

Upon receiving a command which inquires the type of the power supply and the like, the digital video camera 100 returns response data indicating the type of the power supply and the like inquired (S250).

Upon receiving the response from the digital video camera 100, the CPU 501 in the PC 500 determines the type of transcode processing which can be performed by the digital video camera 100 (S260).

The “type of transcode processing” includes whether transcode processing can be performed or not. The CPU 501 in the PC 500 first determines whether or not the digital video camera 100 can perform transcode processing. In the case where the digital video camera 100 is currently driven by the battery 410, the PC 500 determines that the digital video camera 100 cannot perform transcode processing for the reason described later. In the case where the digital video camera 100 is currently driven by the AC adaptor, the PC 500 determines that the digital video camera 100 can perform transcode processing on video data in the digital video camera 100 itself. When transcode processing can be performed, the PC 500 determines the type of transcode processing which can be performed by the digital video camera 100. For example, the PC 500 determines that the digital video camera 100 can transcode video data of 60p into video data of 60i.

Now, the reason why in the case where the digital video camera 100 is driven by the battery 410, the PC 500 determines that the digital video camera 100 cannot perform transcode processing will be described. In many cases, transcode processing takes a longer time than reproduction of video data. Therefore, when the digital video camera 100 is driven by the battery 410, there is a risk that the life of the battery 410 is used up before the transcode processing is completed and the connection state between the digital video camera 100 and the PC 500 cannot be maintained.

When determining that the digital video camera 100 can perform transcode processing and determining the type of transcode processing, the PC 500 waits until receiving an instruction, from the user, to perform the transcode processing using the digital video camera 100 (S270).

Upon receiving an instruction to perform the transcode processing from the user, the PC 500 and the digital video camera 100 start mutual initial negotiation (S280).

[2-2-2. Initial Negotiation Operation]

Now, with reference to FIG. 8, an initial negotiation operation will be described.

When the initial negotiation operation is started (S280), the PC 500 transmits a transcode start request command to the digital video camera 100 (S290). The “transcode start request command” indicates what type of transcode processing is to be requested of the digital video camera 100.

Upon receiving the transcode start request command, the digital video camera 100 notifies the PC 500 of response data indicating a request of prescribed information (S300). The “prescribed information” specifically means information on the video data, on which the PC 500 is to cause the digital video camera 100 to perform transcode processing, and information on the video data obtained as a result of transcode processing being performed thereon. In this embodiment, the “prescribed information” is assumed to be information representing, for example, an image size and a video system of NTSC or PAL.

Upon receiving the response data, the PC 500 transmits the requested information (video information) to the digital video camera 100 (S310).

Upon receiving the video information from the PC 500, the controller 210 of the digital video camera 100 determines whether or not the transcode processing represented by the received video information can be performed (S320).

When determining that the transcode processing cannot be performed, the digital video camera 100 transmits, to the PC 500, response data indicating that the transcode processing cannot be performed (S230).

By contrast, upon determining that the transcode processing can be performed, the digital video camera 100 transmits, to the PC 500, response data indicating that the transcode processing can be performed (S340).

After the response data is transmitted and received, the digital video camera 100 and the PC 500 start an operation necessary to perform the transcode processing (S350).

During the transcode processing, the digital video camera 100 performs a write operation and a read operation in accordance with a request from the PC 500. Hereinafter, the write operation and the read operation will be described.

[2-2-3. Write Operation of the Video Data]

First, with reference to FIG. 10, the write operation of the video data during the transcode processing will be described. When a write mode is started (S400), the PC 500 transmits, to the digital video camera 100, a command inquiring whether or not the video data can be written before the digital video camera 100 to write the video data on the memory 200 of the digital video camera 100 (S410).

Upon receiving the command inquiring whether or not the video data can be written, the digital video camera 100 determines whether or not the video data can be actually written (S420). Specifically, the controller 210 of the digital video camera 100 confirms the capacity of the memory 200 to make this determination.

When determining that the video data cannot be written, the digital video camera 100 transmits, to the PC 500, response data indicating that the video data cannot be written (S430).

By contrast, when determining that the video data can be written, the digital video camera 100 transmits, to the PC 500, response data indicating that the video data can be written (S440). Specifically, the digital video camera 100 transmits information indicating that the video data can be written and indicating the capacity of data which can be written.

Upon receiving the response data, the PC 500 analyzes the response data. When determining that the digital video camera 100 can write the video data, the PC 500 transmits the video data to the digital video camera 100 so that the video data starts to be written on the memory 200 (S450). The PC 500 transmits, to the digital video camera 100, the video data of the capacity permitted by the digital video camera 100. When the write operation of the video data from the PC 500 is started, the controller 210 determines whether or not a prescribed amount of data has been stored on the memory 200 (S460). When the prescribed amount of data has been stored, the controller 210 determines whether or not the image processing section 190 is executing the transcode processing (S470). When the image processing section 190 is not executing the transcode processing, the controller 210 controls the image processing section 190 to perform the transcode processing on the video data stored on the memory 200. Owing to this, the image processing section 190 starts the transcode processing (S480).

[2-2-4. Read Operation of the Video Data]

Now, with reference to FIG. 12, the read operation of the video data during the transcode processing will be described. When a read mode is started (S500), the PC 500 transmits, to the digital video camera 100, a command inquiring whether or not the video data can be read before reading the video data from the memory 200 of the digital video camera 100 (S510).

Upon receiving the command inquiring whether or not the video data can be read, the digital video camera 100 determines whether or not the video data can be actually read (S520). Specifically, the controller 210 of the digital video camera 100 determines whether or not a prescribed amount of transcoded video data has been stored on the memory 200.

When determining that the video data cannot be read, the digital video camera 100 transmits, to the PC 500, response data indicating that the video data cannot be read (S530).

By contrast, when determining that the video data can be read, the digital video camera 100 transmits, to the PC 500, response data indicating that the video data can be read (S540). Specifically, the digital video camera 100 transmits information indicating that the video data can be read and indicating the capacity of data which can be read.

Upon receiving the response data, the PC 500 analyzes the response data. When determining that the video data can be read from the digital video camera 100, the PC 500 transmits a read request to the digital video camera 100 and starts reading the transcoded video data from the digital video camera 100 (S550).

This processing will be described in more detail. The transcode block 350 in the image processing section 190 of the digital video camera 100 has transcoded the video data received from the PC 500. When the communication path control block 310 of the controller 210 receives a read request from the CPU 510 of the PC 500 during this transcode processing, the communication path control block 310 sequentially transmits the video data, generated as a result of the completion of the transcode processing, to the PC 500 via the USB interface 290. The PC 500 continues reading the video data until the data of the capacity permitted by the digital video camera 100 is read. Because the PC 500 sequentially reads the video data on which the transcode processing has been completed, the transfer of the transcoded video data can be completed soon after the transcode processing is finished.

In the above description, the video data is sequentially read during the transcode processing. Alternatively, the PC 500 may read the transcoded video data after the transcode processing on all the video data is completed, without reading the video data until the transcode processing on all the video data is completed. The digital video camera 100 may store the transcoded video data on a storage medium such as the built-in HDD 300 or the like until the transcode processing is completed.

This processing will be described in more detail. The transcode block 350 in the image processing section 190 of the digital video camera 100 transcodes the video data received from the PC 500. When the transcode processing is completed, the communication path control block 310 notifies the PC 500 of the completion of the transcode processing. Then, as a response to the notification, the communication path control block 310 receives a read request from the CPU 501 of the PC 500. The communication path control block 310 sequentially transmits the video data, generated as a result of the completion of the transcode processing, to the PC 500 via the USB interface 290.

Owing to this, during the transcode processing which requires several hours, the PC 500 does not need to read data from the digital video camera 100. Therefore, the user can perform other operations using the PC 500.

Instead of the PC 500 reading the data, the digital video camera 100 may output a transmission request to the PC 500. In this case, after the PC 500 responds to the transmission request, the digital video camera 100 may transmit the transcoded video data to the PC 500.

As described above, the digital video camera 100 in this embodiment can perform transcode processing on video data stored on the memory card 240 and the HDD 300. The digital video camera 100 can also perform transcode processing on video data received from the PC 500. Owing to this, there is no need to prepare a dedicated transcode device for performing transcode processing on video data stored on the PC 500. If transcode processing is performed in the PC 500, the resource in the PC 500 such as a memory or the like needs to be used. This increases the processing load on the PC 500 during the transcode processing. However, when transcode processing is performed using the digital video camera 100, there is almost no need to prepare the resource necessary for the transcode processing, such as a memory or the like, for the PC 500. Thus, even during the transcode processing, the user can continue other operations using the PC 500.

The embodiment of the present invention has been described. The present invention is not limited to the above. Now, a modification of the above embodiment will be described.

The optical system and the driving system of the digital video camera 100 in Embodiment 1 are not limited to the example shown in FIG. 2. For example, FIG. 2 shows a structure in which light is incident on the CCD 180 via the optical system formed of three elements. However, any other type of lens structure may be used. Alternatively, each lens system of the three-element optical system in FIG. 2 maybe formed of one lens or a plurality of lenses.

In this embodiment, the CCD image sensor 180 is shown as an example of the image capture element, but the present invention is not limited to this. For example, the image capture element may be a CMOS image sensor or an NMOS image sensor.

The digital video camera 100 in this embodiment includes the HDD 300 and the memory card 240 as the storage mediums. However, the storage medium is not limited to these. For example, the storage medium may be a built-in flash memory, a DVD, a BD (Blu-ray Disc) or the like. Any medium which can store data is usable.

In this embodiment, in the case where the connection state of the digital video camera 100 with the PC 500 does not allow transcode processing to be performed, the digital video camera 100 once cancels the connection with the PC 500 and then is connected again in the state in which the transcode processing can be performed (FIG. 6, steps S220 and S230). However, this processing is merely an example. As another type of processing, for example, the digital video camera may change the connection state into a state in which transcode processing can be performed while being connected to the PC.

The digital video camera 100 in Embodiment 1 has the memory 200 in the digital video camera 100 itself as an intermediate memory used for transcode processing. This is merely an example. As another type of processing, for example, an external storage medium such as the memory card 240 or the like may be used as an intermediate memory used for transcode processing.

The computer program 201 (FIG. 2) executable by the digital video camera 100 and the computer program 510 (FIG. 4) executable by the PC 500 described above may be distributed on the market as a product as being recorded on a storage medium such as a CD-ROM or the like, or may be transferred via an electrical communication line such as the Internet or the like.

The present invention is applicable to an image capture device such as a digital video camera, a digital still camera or the like and an electronic device such as a PC or the like.

1. An image capture device having an image capture function, comprising:
an interface which receives first data from an external electronic device; and
a processing section including a circuit which is used for transcode processing, the processing section performing the transcode processing on the first data using the circuit to generate second data;
wherein the interface transmits the second data to the electronic device.

2. The image capture device of claim 1, further comprising a controller which controls communication with the electronic device via the interface, wherein:
the image capture device is driven by power of a power supply provided from an electrical outlet or by power supplied from a battery;
before the interface receives the first data, the controller transmits information specifying the type of the power supply currently driving the image capture device to the electronic device via the interface; and
when the image capture device is currently driven by the power of the power supply, the interface receives the first data from the electronic device.

3. The image capture of claim 1, further comprising a controller which controls communication with the electronic device via the interface, wherein:
before receiving the first data, the interface receives information specifying the type of the transcode processing from the electronic device; and
based on the information specifying the type of the transcode processing, the controller determines whether or not the specified type of transcode processing can be performed on the first data; and when determining that the specified type of transcode processing can be performed on the first data, the controller transmits response data which indicates that the transcode processing can be performed to the electronic device via the interface, and then the interface receives the first data from the electronic device.

4. The image capture device of claim 1, further comprising:
a controller which controls communication with the electronic device via the interface; and
a storage section which stores the first data;
wherein the controller determines whether or not a prescribed amount of the first data has been stored on the storage section; and when the prescribed amount of the first data has been stored on the storage device, the processing section performs the transcode processing on the first data using the circuit.

5. The image capture device of claim 1, further comprising a controller which controls communication with the electronic device via the interface, wherein:
the controller transmits a part of the second data generated by the transcode processing performed on the first data to the electronic device via the interface before the transcode processing is completed.

6. The image capture device of claim 1, further comprising a controller which controls communication with the electronic device via the interface, wherein:
the controller transmits the second data to the electronic device via the interface after the transcode processing on the first data is completed.

7. An electronic device to be connected with the image capture device including a circuit which is used for transcode processing, the image capture device being driven by power of a power supply provided from an electrical outlet or by power supplied from a battery, and the electronic device comprising:
an interface which receives, from the image capture device, information specifying the type of the power supply currently driving the image capture device;
a storage section which stores first data; and
a processor which determines whether or not to transmit the first data to the image capture device in accordance with the type of the power supply currently driving the image capture device;
wherein:
when the image capture device is currently driven by the power of the power supply, the processor transmits the first data to the image capture device via the interface, and receives second data obtained by the transcode processing performed on the first data using the circuit; and
when the image capture device is currently driven by the battery, the processor does not transmit the first data to the image capture device.

8. The electronic device of claim 7, wherein before transmitting the first data, the processor transmits information specifying the type of the transcode processing to the image capture device via the interface, and receives, from the image capture device, response data which indicates whether or not the transcode processing of the type specified by the information can be performed.

9. The electronic device of claim 8, wherein in the case where the response data indicates that the transcode processing of the type specified by the information can be performed, the processor transmits the first data to the image capture device.

10. The electronic device of claim 7, wherein the processor receives a part of the second data generated by the transcode processing performed on the first data from the image capture device via the interface before the transcode processing is completed.

11. The electronic device of claim 7, wherein the processor receives the second data from the image capture device via the interface after the transcode processing on the first data is completed.

12. A data processing system, comprising an electronic device and an image capture device having an image capture function, wherein:
the electronic device includes:
a storage section which stores first data; and
a first interface which transmits the first data to the image capture device;
the image capture device includes:
a second interface which receives the first data from the electronic device; and
a processing section including a circuit which is used for transcode processing, the processing section performing the transcode processing on the first data using the circuit to generate second data;
the image capture device transmits the second data via the second interface; and
the electronic device receives the second data via the first interface.

13. A computer program executable by a computer of an image capture device having an image capture function and stored on a non-transitory storage medium, wherein:
the image capture device includes a controller acting as a computer, an interface, and a processing section including a circuit usable for transcode processing; and
the computer program causes the controller to execute the steps of:
receiving first data from an external electronic device via the interface;
performing the transcode processing on the first data using the circuit to generate second data; and
transmitting the second data to the electronic device via the interface.

14. A computer program executable by a computer of an electronic device and stored on a non-transitory storage medium, wherein:
the electronic device includes a computer, a storage section which stores first data and an interface, and is connected with an image capture device;
the image capture device includes a circuit which is used for transcode processing, and the image capture device is driven by power of a power supply provided from an electrical outlet or power supplied from a battery;
the computer program causes the computer to execute the steps of:
receiving information specifying the type of the current driving power supply from the image capture device via the interface;
not transmitting the first data to the image capture device when the image capture device is currently driven by the battery, and transmitting the first data to the image capture device via the interface when the image capture device is currently driven by the power of the power supply; and
receiving, via the interface, second data obtained by the transcode processing performed on the first data using the circuit when the first data is transmitted to the image capture device.
